(19) United States
(12) Patent Application Publication
(10) Pub. No.: US 2010/0212642 A1
(43) Pub. Date: Aug. 26, 2010

(54) Fluid Metering Unit and Fluid Metering System

(76) Inventors: Bernhard Gottlieb, Munchen (DE); Andreas Kappel, Brunnthal (DE); Tim Schwebel, Munchen (DE); Carsten Wallenhauer, Schwarzheide (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/293,770

(22) PCT Filed: Mar. 22, 2007
(86) PCT No.: PCT/EP07/52721

§ 371 Date: Sep. 19, 2008

(30) Foreign Application Priority Data
Mar. 23, 2006 (DE) 10 2006 013 512.1

(51) Int. Cl. F02M 21/02

(52) U.S. Cl. 123/525

(57) ABSTRACT

A fluid metering system has a metering valve, which is located between a supply region and a fluid metering region and an actuator drive that converts the elongation of at least two drive elements into the rotation of a drive shaft, the shaft being mechanically coupled to the metering valve, driving the latter for the metering process.

### CROSS-REFERENCE TO RELATED APPLICATIONS

This application is a U.S. national stage application of International Application No. PCT/EP2007/052721 filed Mar. 22, 2007, which designates the United States of America, and claims priority to German application number 10 2006 013 512.1 filed Mar. 23, 2006, the contents of which are hereby incorporated by reference in their entirety.

### TECHNICAL FIELD

The invention relates to a system for metering pressurized fluids and to a device which is suitable for this purpose. Metering is provided e.g. for gases which are delivered via injectors or directly to an induction manifold in a vehicle, for example, in order that they can be prepared for combustion in the cylinder of an internal combustion engine.

### BACKGROUND

In the case of injectors which are provided for use in gas-driven motor vehicles, an operating pressure of maximal bandwidth is desirable for the purpose of adapting to the running requirements. It is particularly desirable to use the whole operating pressure range of compressed gas accumulators which are customarily utilized for supplying gas, said range being limited by an extreme lower and upper value. The capacity utilization of the accumulator is directly related to the pressure therein. High gas pressures entail a considerable hazard potential in the event of accidents, for example. The upper permissible limit value of a compressed gas accumulator is determined essentially by the effort that is required for safe handling of the high gas pressures in the motor vehicle. Given a predetermined upper operating pressure limit, the maximal quantity of gas that is available in the motor vehicle is determined by the volume of the compressed gas accumulator. By contrast, the distance that can be covered by the motor vehicle is determined by the maximal quantity that can be extracted. Injectors have a lower operating pressure limit, below which it is no longer possible to guarantee gas proportioning of sufficient quality for the subsequent combustion process. The lower operating pressure limit of the injector is directly related to a residual gas quantity which is carried in the compressed gas accumulator but which cannot be used. The requirement placed on gas supply systems in motor vehicles, namely to cover a significant distance using suitably safe and economical maximal operating pressures and minimal accumulator volumes, gives rise to the requirement for gas injectors to allow a lower operating pressure that is as low as possible, approximately 10 to 20 bar, at the same time as a specified maximal operating pressure, since this minimizes the residual gas quantity that cannot be used and maximizes the gas extraction quantity, this being critical in relation to the distance that can be covered.

In order to address the above-described demanding technical requirements placed on injectors, said requirements being directly related to the compressed gas accumulator and being expensive to implement, a two-stage fuel supply system has been designed. In the first phase, it consists of a gas extraction system for extracting gas from the accumulator. The extraction operating pressure range on the accumulator side is delimited by a lower limit of approximately 20 bar, this being as low as possible, and an upper limit of up to approximately 300 bar, this corresponding to the maximal operating pressure of the accumulator. The output operating pressure of the gas extraction system on the injector side is a constantly adjustable value in the range of approximately 10 bar to approximately 20 bar. The second stage consists of low-pressure injectors that meter the gas, which is provided at constant low pressure from the gas extraction system, into the induction manifold of an internal combustion engine. Such a technical solution has the advantage that economical solenoid valves can be utilized for proportioning of the gas quantity at constant low pressure. This solution has the further advantage that, in the case of a low-price variant which can be used e.g. in countries having higher emission limit values, the gas extraction system alone can control the proportioning of the gas quantity.

The prior art discloses e.g. customary spring-loaded pressure reducers or regulated solenoid valves for regulating gas extraction systems having corresponding lower pressures on the extraction side.

### SUMMARY

An improved fluid metering device and an improved system for fluid metering can be provided.

According to an embodiment, a fluid metering device may comprise a) a metering valve that is arranged between a supply region and a fluid metering region an actuator drive that converts an elongation of at least two drive elements into a rotation of a drive shaft, which is mechanically coupled to the metering valve and drives said valve for the purpose of metering.

According to a further embodiment, the metering valve may be arranged in the supply region and may have a valve seat which is subjected to a reservoir pressure. According to a further embodiment, the drive elements can be designed as linear drives. According to a further embodiment, the actuator drive may have at least two electromechanical drive elements, at least one drive ring which is shunted by the two drive elements into a rotating displacement movement, and one drive shaft which is surrounded by the drive ring and is connected to it frictionally or positively, the external diameter of the drive shaft being smaller than the internal diameter of the drive ring. According to a further embodiment, the actuator can be embodied as a piezoelectric multi-layer actuator. According to a further embodiment, the actuator drive can be arranged on a chassis which is directly coupled to the pressure reservoir region. According to a further embodiment, the drive shaft can be coupled to the valve via an eccentric or a cam disk. According to a further embodiment, a roller construction can be arranged between the eccentric or the cam disk and the metering valve. According to a further embodiment, the valve seat can be followed by a valve inner space that is connected to the fluid metering region. According to a further embodiment, a valve element that closes the valve seat can be driven axially, wherein a sealing element can be arranged between the valve element and the valve body in order to provide a seal. According to a further embodiment, the valve may have an inner seat. According to a further embodiment, the valve may have an outer seat.

According to a further embodiment, a measurement sensor can be arranged in the fluid metering region. According to a further embodiment, the fluid metering region can be connected to a pressure fluid injector in a fluid-carrying manner. According to a further embodiment, the fluid metering device may comprise a control device which receives measurement signals from the measurement sensor and is coupled to the drive such that it can control the drive depending on the signals supplied by the measurement sensor.

According to another embodiment, a system for fluid metering, may comprise such a fluid metering device, wherein a relationship between an angle of rotation of the drive shaft and a measured value of the measurement sensor and control instructions for a drive element is stored in the control unit, and the system controls the drive such that a predeterminable pressure is set in the fluid metering region.

According to a further embodiment, the relationship can be stored as a model. According to a further embodiment, the relationship can be stored as a characteristic curve.

### BRIEF DESCRIPTION OF THE DRAWINGS

The invention is explained in further detail below with reference to figures and exemplary embodiments.

FIG. 1 shows an electromechanical motor which is particularly suitable for driving the fluid metering device according to an embodiment.

FIG. 2 shows an exemplary embodiment of a fluid metering device.

FIG. 3 shows a further exemplary embodiment of a fluid metering device.

### DETAILED DESCRIPTION

According to various embodiments, a fluid metering device may have a metering valve that is arranged in the fluid metering region and is driven via at least two elongatable drive elements which cause rotation of a drive shaft that is mechanically coupled to the metering valve. In this way, provision can advantageously be made for a self-locking valve drive possibility, and a strong dynamic effect can be accurately introduced via suitable drive elements such as piezoelectric actuators.

Furthermore, according to an embodiment, a fluid metering device advantageously may have a metering valve which is rigidly arranged in a supply region and has a valve seat which is subjected to the reservoir pressure, thereby allowing the force of the high pressure in the reservoir to be used for resetting the valve.

Furthermore, in according to an embodiment, a fluid metering device may have at least two electromechanical drive elements, which shunt at least one drive ring into a rotating displacement movement, and a drive shaft which is surrounded by this drive ring and is connected to it frictionally or, due to the higher achievable positioning force and positioning accuracy, positively in the form of a microtooth gearing. The diameter differences between the external diameter of the drive shaft and the internal diameter of the drive ring, or the toothed gear pairing between drive ring and drive shaft in the case of the positive fit, are adapted to the travel differences of the actuators.

When using multi-layer piezoelectric actuators, it is thus advantageously possible to apply a strong force, which is required to control the proportioning of gas in the high-pressure region, and to meter the positioning of the valve very accurately.

In a further embodiment of the fluid metering device, the drive shaft is advantageously coupled to the valve via an eccentric.

This can advantageously also be done by means of a cam disk. Given a constant rotation of the drive shaft, a non-linear thrust movement can therefore be achieved by virtue of the eccentric disk or cam disk having a suitable contour.

The eccentric disk or cam disk is advantageously connected to the valve via a roller construction, thereby ensuring that positioning of the valve involves minimal friction, optimally precise metering, and is as smooth as possible.

Furthermore, according to an embodiment, the fluid metering device has a valve inner space which is arranged behind the valve seat of the valve and is connected to the metering region, thereby making it possible with a technical minimum of structural effort to create an environment having constant pressure, e.g. for use in motor vehicles.

In addition, it is easily possible to control the metering pressure in the fluid metering region in this way.

Furthermore, according to an embodiment, a fluid metering device advantageously may have an axially operable valve element which closes the valve seat, a sealing element being arranged between the valve element and a valve body in order to provide a seal.

By virtue of this technical solution, it is not necessary to seal the high pressure of the accumulator relative to the environment, but only the metering pressure in the fluid metering region. As a result of this, economical metal bellow-type sections or membranes can be used when creating a seal. Inexpensive elastomer seals or O-rings can also be used as sealing elements if applicable.

In a development of the device, provision is advantageously made for a valve with an inner seat, because the pressure which is present in the accumulator can be used for opening the valve in this case.

In a development of the device, provision is advantageously made for a metering valve with an outer seat, because such a valve allows the pressure of the accumulator to be used for closing the valve. As a result of this, the valve drive does not have to generate a constant closing force.

Furthermore, according to an embodiment, a fluid metering device advantageously may have a measurement sensor which is arranged in the fluid metering region in order to determine the current operating states. By virtue of such measurement sensors, suitable actuating variables can be specified for the valve drive, in order to achieve an operating pressure that is as constant as possible in the fluid metering region. Furthermore, according to an embodiment the fluid metering device is provided with, in its fluid metering region, to be connected to a pressure fluid injector in a fluid-carrying manner, since this advantageously may provide a technically simple design which allows the operation of the fluid metering device in a motor vehicle.

According to an embodiment, a control device is coupled to the fluid metering device, which receives measurement signals from the measurement sensor and is coupled to the drive such that it can control the drive depending on the signals supplied by the measurement sensor, and therefore no regulation of the drive is necessary.

Furthermore, according to an embodiment, a system for fluid metering is provided, which system has a fluid metering device and a control unit, where a relationship between an angle of measurement sensor and associated control instructions for a drive element is stored, and the system controls the drive such that a predeterminable pressure is set in the fluid metering region. In this way, it is advantageously possible to dispense with a regulator and to achieve a maximally constant operating pressure in the fluid metering region.

Furthermore, according to an embodiment, the relationship can be stored as a model.

Furthermore, according to an embodiment, the relationship can be stored in the form of a characteristic map.

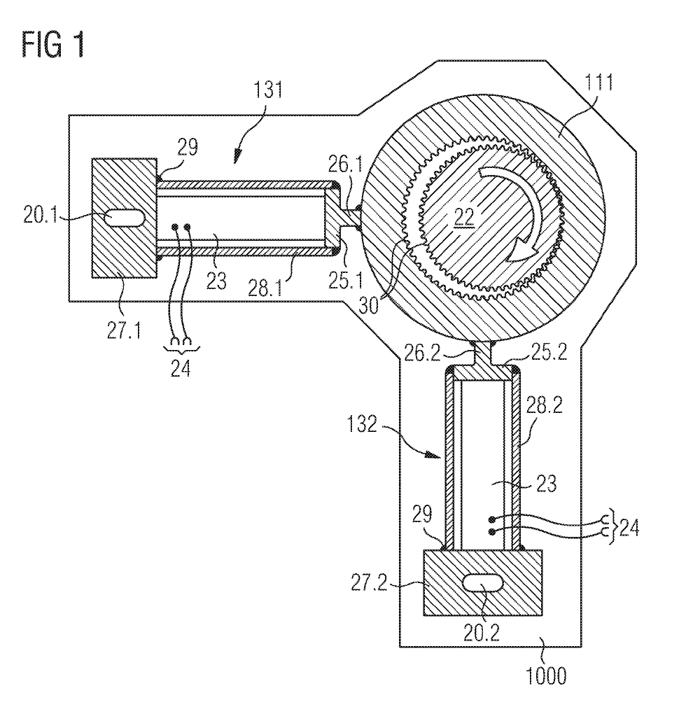

FIG. 1 shows an electromechanical motor as an example of a drive. This preferably consists at least of a mechanical base plate 1000, in which the shaft 22 or the motor is rotatably guided in a manner that is as free from play as possible by means of a bearing. Provision is further made for a first mechanical drive element 131 and a second mechanical drive element 132, each having a piezoelectric low-voltage multilayer actuator 23 (PMA). The PMAs 23 can be activated in each case by an electrical amplifier via electrical leads 24. In the context of the invention, however, an electromechanical drive element (PMA) 23 can also utilize any other actuator featuring automatic longitudinal expansion such as e.g. an electromagnetic, electrodynamic, electrostrictive or magnetostrictive actuator, or in the form of a linear drive. As a result of electrical activation of the PMA 23, it can expand in an axial direction in accordance with the characteristics of a piezoelectric longitudinal actuator, said expansion being approximately proportional to the electrical voltage that is applied. Each PMA 23 is installed under high mechanical compressive prestress between an end plate having a ram 26 and a bearing block 27 and a tube spring 28, the latter being as mechanically weak as possible, e.g. slotted. The mechanical compressive prestress serves both to avoid any damage to the PMA 23 as a result of tensile stress forces which can otherwise occur in high-frequency continuous operation, and to reset the PMA 23 when it is electrically discharged.

Since the travel of the PMA 23 is restricted by the tube spring 28, this should have a spring constant which is as small as possible with reference to the stiffness of the piezoelectric actuator.

A permanently fixed connection of the PMA 23, end plate 25, bearing block 27 and tube spring 28 is achieved by means of welded connections 29. The bearing block can be permanently connected to the base plate 1000 by means of screws which are passed through elongated holes 20. This connection can also be provided using other means, e.g. by welding the bearing block 27 to a base plate 1000. The electromechanical motor has a concentric drive ring 111 which is as stiff and lightweight as possible, having a diameter dR which is somewhat larger than the diameter dM of the shaft 22. The drive ring 111 is welded to the rams 26 in such a way that it has a clearance relative to the base plate 1000 and can therefore move freely over the base plate 1000. The drive elements 131, 132, which are permanently connected to the base plate 1000 via the bearing blocks 27, are arranged at an angle of 90° relative to each other on the plane of the base plate 1000, this corresponding to the plane of movement here, their main direction of effect being directed towards the center of the drive ring 111. This embodiment avoids the disadvantages of the previously known piezoelectric drives by virtue of the rolling contact of the rotatably mounted shaft 12 on the inside of the drive ring 111 which is periodically displaced in a circular manner by the drive elements 131, 132, wherein the typical advantages of a piezoelectric motor are entirely retained.

For the purpose of generating the circular displacement movement of the drive ring 111, the two drive elements 131, 132 are preferably activated by two sinusoidal voltage signals which are phase shifted by 90° and have identical peak amplitude. The gap dimension between the shaft 22 and the inner surface of the drive ring 111 is configured, in conjunction with the properties of the PMAs 23 and an assembly of the motor, in such a way that a strong frictional engagement occurs between the shaft 22 and the drive ring 111 during each phase of the rolling contact movement, in particular even when the motor is switched off, at which time the two PMAs 23 are without voltage. A microtooth gearing 30 is preferably provided between the shaft 22 and the drive ring 111, and ensures a positive engagement between the shaft 22 and the drive ring 111. This has the effect of improving the force transfer and increasing the positioning accuracy. This means that the motor is self-locking in any operating state and can be used particularly effectively for the valve operation of the gas pressure valve or metering valve in the context of the fluid metering device according to an embodiment, since it is subjected to and withstands the high pressure forces caused by the high pressures even in the idle state.

Such a drive motor, which makes use of PMAs, is disclosed in EP 1098429 B1, for example, where further details and embodiments of such drives are also specified.

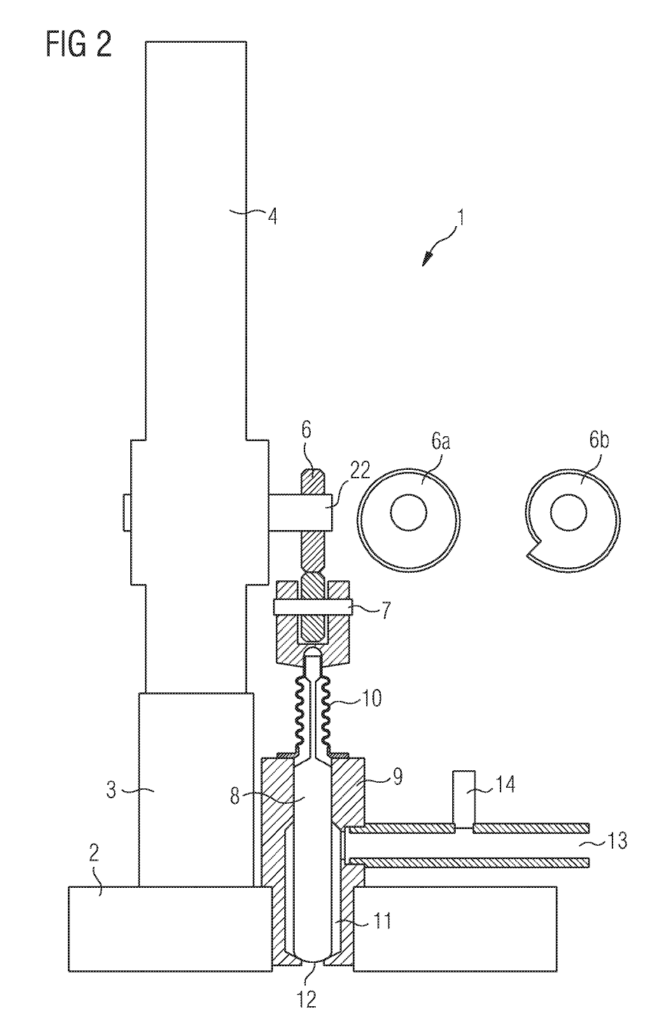

FIG. 2 shows an exemplary embodiment of a fluid metering device as assembled. In this exemplary embodiment, a high pressure region 1 of the gas accumulator is delimited by a container wall 2. Instead of a gas, it is also possible to meter liquids using the fluid metering device. A chassis 3 is fastened to a section of the container wall 2 in a mechanically rigid manner, and is used for fastening the schematically illustrated drive 4 in a likewise mechanically rigid manner. Due to the high forces that are required, the preference for self-locking, and the compact dimensions, it is particularly advantageous to use piezoelectric actuator drives. Arranged on the drive shaft 22 of the drive 4, said shaft being rotatably mounted relative to its axis of symmetry, is e.g. an eccentric disk 6a or a cam disk 6b featuring a suitably shaped outer contour. The eccentric disk or the cam disk is attached for example by means of a mechanically rigid connection technique such as e.g. a feather key, a toothed wheel, a press fit or similar. In this exemplary embodiment, the cam disk advantageously rolls in contact with a rotatably mounted roller construction 7 which has a mechanically rigid active connection to the valve element 8. In this embodiment, the valve element 8 is axially guided in the form of a narrow clearance fit at the top end of the valve body 9, such that it has minimal leakage and forms a seat valve 12 with the valve body at the opposite bottom end of the valve body 9. By means of a sealing element which is attached to the valve element 8 and the valve body 9 in a hermetically impervious manner, and is fastened e.g. by welding, the valve element is sealed against the environment. For this, it is advantageous that a pressure loading capacity of up to only approximately 40 bar is required in respect of the sealing element, wherein e.g. a metal bellow-type section or a membrane or even elastomer seals or O-rings can be used as a sealing element 10. In this context, it is important that they allow sufficient axial clearance for the repositioning of the valve element 8 which occurs during operation. The low-pressure region or fluid metering region consists of a valve inner space or annular space 11, which is situated behind the valve seat, and a low-pressure line 13 which leads to the injection manifold or to low-pressure injectors, for example, and is sealed against the environment in a hermetically impervious manner. As shown in this exemplary embodiment, a temperature sensor 14 or also a pressure sensor is advantageously arranged in the low-pressure line, allowing the momentary gas flow in the low-pressure region to be determined via control electronics.

The full operating pressure of the gas accumulator has effect on that side of the valve element 8 which is oriented towards the high-pressure region 1 or gas/supply region. The escape of gas is prevented only by the seal line of the seat valve.

The pressure here is e.g. up to 300 bar. In the case of a typical sealing seat diameter of approximately 8 mm, the valve element 8 is loaded with a pressure force of up to 1500 N in this exemplary embodiment.

In the context of these high loads, with regard to the valve travel which is small in practice, particular importance is placed on the rigid construction of the design of its coupling to the gas container and the interconnection of the parts. The chassis 3, the drive 4, the drive shaft 22 with cam disk 6, and the roller construction 7 should therefore never manifest any deformations as a result of such loads, or these should at least be so small that they can be correctively accommodated when the actuating variables of the drive are specified. The chassis 3 can be designed as a stiff honeycomb construction, for example. In another case, which is not shown here, the drive shaft can have two bearings, the eccentric or cam being situated between two permanently fixed bridge piers, each of which holds a shaft bearing.

At its upper end, the valve element 8 is braced against the drive shaft 22 via the roller construction 7 and the cam disk 6. By means of electrical activation, e.g. via a control unit which is not represented in greater detail, the drive is induced to start the shaft 22 rotating, whereby the center distance between the motor shaft and the contact line of the roller becomes smaller by virtue of the cam disk and the valve element moves upwards due to the pressure force, for example. A gap therefore opens between the valve element and the valve body in the region of the seal line, such that pressurized gas can flow through the valve in a throttled manner out of the high-pressure region 1 into the fluid metering region and away through the low-pressure line 13. By means of the sensor signals that relate to pressure and temperature and are supplied by the sensor 14, the momentary gas mass flow is determined by control electronics (not shown) and compared with the reference value of a motor control unit, said reference value being stored in the system.

Because a simple and specific relationship exists between the position of the valve element and the momentary gas mass flow, and a specific relationship exists between the controlled angle of rotation of the motor shaft of the drive and the position of the valve element via the cam disk, a new angle of rotation of the motor shaft is calculated and can be started in a controlled manner by the control electronics in the event of a deviation from the reference value. This relationship can be stored e.g. in the control electronics (not shown here) as a model or as a characteristic curve range.

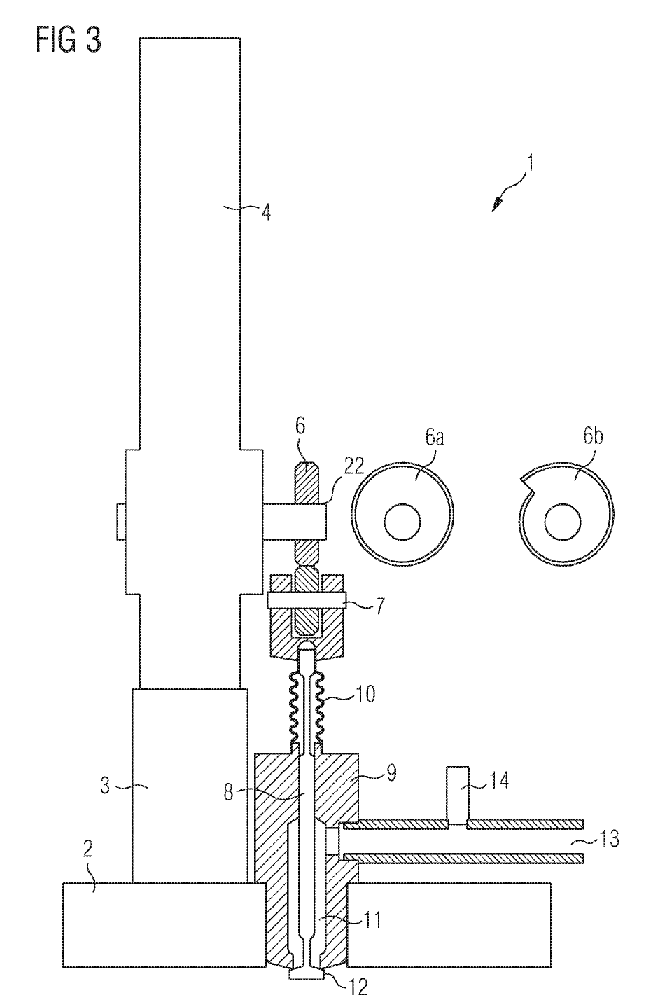

FIG. 3 shows a further exemplary embodiment of a fluid metering device. In contrast with the embodiment in FIG. 2, the valve element has an external seat 12. The valve which is illustrated in FIG. 3 is therefore closed by the high pressure which exists in the gas pressure region 1, and has to be opened by means of a suitable driving force which acts on the seat via the shaft 5, the disk 6, the roller drive 7 and the valve element 8. The function is otherwise identical to the embodiment illustrated in FIG. 2.

The fluid metering device according to an embodiment has the following particular advantages. A piezoelectric actuator drive in accordance with EP 1 098 429 B1 with microtooth gearing has an extremely high positioning accuracy and has a very high repetitive accuracy in respect of the angle position. The valve element can therefore be controlled with very high precision by means of this piezoelectric actuator drive.

Furthermore, as a result of its principle, the piezoelectric actuator drive features a high drive stiffness and is therefore insensitive to a load change such as that caused e.g. by dynamic pressure changes in the valve region. Precise control and rapid control of the valve element are further assisted by this property.

In principle, considerable paths of travel of the valve element can be realized in the mm range with the aid of this piezoelectric actuator drive, whereby a very extensive pressure range of the accumulator becomes usable.

When holding a set angle and an associated valve position, the piezoelectric actuator drive does not consume any electrical energy, because piezoelectric actuators as capacitive and high-impedance components do not require any electrical energy to hold a charge state.

By means of a suitably shaped cam disk, the power output of the piezoelectric actuator drive can be optimally adapted to the power required to move the valve element throughout the whole operating pressure range.

The invention combines a mechanically compact drive with a high-pressure valve, thereby providing a fluid metering device of simple construction and modest dimensions. The mechanical properties of the drive and the valve that is used are such that they are particularly suitable for use in the preparation of the gas mixture in a gas combustion engine.

1. A fluid metering device comprising
a) a metering valve that is arranged between a supply region and a fluid metering region
an actuator drive that converts an elongation of at least two drive elements into a rotation of a drive shaft, which is mechanically coupled to the metering valve and drives said valve for the purpose of metering.

2. The fluid metering device according to claim 1, in which the metering valve is arranged in the supply region and has a valve seat which is subjected to a reservoir pressure.

3. The fluid metering device according to claim 1, wherein the drive elements are designed as linear drives.

4. The fluid metering device according to claim 1, in which the actuator drive has at least two electromechanical drive elements, at least one drive ring which is shunted by the two drive elements into a rotating displacement movement,
and one drive shaft which is surrounded by the drive ring and is connected to it frictionally or positively, the external diameter of the drive shaft being smaller than the internal diameter of the drive ring.

5. The fluid metering device according to claim 1, in which the actuator is embodied as a piezoelectric multi-layer actuator.

6. The fluid metering device according to claim 1, in which the actuator drive is arranged on a chassis which is directly coupled to the pressure reservoir region.

7. The fluid metering device according to claim 1, in which the drive shaft is coupled to the valve via an eccentric or a cam disk.

8. The fluid metering device according to claim 7, in which a roller construction is arranged between the eccentric or the cam disk and the metering valve.

9. The fluid metering device according to claim 2, in which the valve seat is followed by a valve inner space that is connected to the fluid metering region.

10. The fluid metering device according to claim 2, in which a valve element that closes the valve seat can be driven axially, wherein a sealing element is arranged between the valve element and the valve body in order to provide a seal.

11. The fluid metering device according to claim 9, wherein the valve has an inner seat.

12. The fluid metering device according to claim 9, wherein the valve has an outer seat.

13. The fluid metering device according to claim 1, in which a measurement sensor is arranged in the fluid metering region.

14. The fluid metering device according to claim 1, in which the fluid metering region is connected to a pressure fluid injector in a fluid-carrying manner.

15. The fluid metering device according to claim 13, comprising a control device which receives measurement signals from the measurement sensor and is coupled to the drive such that it can control the drive depending on the signals supplied by the measurement sensor.

16. A system for fluid metering, having a fluid metering device according to claim 14, wherein a relationship between an angle of rotation of the drive shaft and a measured value of the measurement sensor and control instructions for a drive element is stored in the control unit, and the system controls the drive such that a predeterminable pressure is set in the fluid metering region.

17. The system as claimed in claim 16, in which the relationship is stored as a model.

18. The system as claimed in claim 16, in which the relationship is stored as a characteristic curve.
